(19) United States
(12) Patent Application Publication
(10) Pub. No.: US 2013/0030644 A1
(43) Pub. Date: Jan. 31, 2013

(54) Method and apparatus for controlling audio/video devices via control keys on steering wheel

(71) Applicant: Jason Kemmerer, Torrance, CA (US)

(72) Inventor: Jason Kemmerer, Torrance, CA (US)

(21) Appl. No.: 13/136,191

(22) Filed: Jul. 26, 2011

(51) Int. Cl. G06F 17/00

(52) U.S. Cl. 701/36; 701/1

(57) ABSTRACT

A method and apparatus selectively controls operations of an original device and a non-original device in a vehicle through control keys mounted on a steering wheel. The method includes the steps of: interpreting a command code from the control key when the control key is activated to determine which function is selected; selecting one or more original or non-original devices to substantiate the selected function of the control key; retrieving data related to a command code of the selected function of the non-original device; converting the command code from the control key to a command code of the selected function of the non-original device and storing the converted command code; and retrieving and transmitting the converted command code and transmitting to the non-original device when the control key is activated again.

### FIELD OF THE INVENTION

This invention relates to a method and apparatus for controlling audio/video devices via control keys on a steering wheel of a vehicle. More particularly, this invention relates to a method and apparatus for selectively controlling a plurality of audio/video devices via control keys on the steering wheel through an interface unit which is designed to interface between the control keys and the plurality of audio/video devices.

### BACKGROUND OF THE INVENTION

In addition to assisting a driver to operate a vehicle, most current steering wheels are equipped with a number of control keys in a way that can be easily accessed by a driver. These control keys are used to control volume, music channel or track of an audio/video device, change audio disc and FM-AM band, operations of a cellular phone via Bluetooth, etc. The main purpose of equipping such control keys on a small area of the steering wheel is to minimize the driver's distraction from the driving when adjusting and controlling audio/video devices in the vehicle.

FIG. 1A shows an example of such a steering wheel 20 having two steering wheel control key assemblies 22 each having a plurality of control keys 22a, 22b, 22c and 22d. One control key assembly 22 may be used to control an audio system such as increase or decrease sound volume, change channels, switch modes such as between AM and FM, etc. Another control key assembly 22 may be used to control operations of a hands-free telephone system such as call, call end, refuse, voice commands, etc.

FIG. 1B is a block diagram showing an example of electrical circuit structure of the steering wheel control key assembly 22 related to a conventional steering wheel equipping with a plurality of control keys shown in FIG. 1A. The steering wheel control key assembly 22 may include a steering wheel interface module 23 which includes a processing unit 24 in communication with a memory 26 and an interface unit 28 for communication with an external device such as a vehicle audio/video device, a cellar phone, etc. The processing unit 24 operates in accordance with program stored in the memory 26.

The steering wheel control key assembly 22 may also include a plurality of control keys 22a-22d as noted above which will be operated by a user to select and transmit signals to the processing unit 24. The processing unit 24 interprets the information from the control keys 22a-22d and selects the corresponding command codes. The processing unit 24 transmits the selected command codes to the interface unit 28 which is adapted to format the command codes (ex. channels, volumes, etc.) from the processing unit 24 and then transmits them to the audio/video device, cellar phone, etc., in the vehicle.

In many occasions, such control keys on the steering wheel are used for controlling an operation of an audio/video device or a head unit equipped in a vehicle. Here, when such an audio/video device or head unit is already equipped in a vehicle when a user purchases the vehicle, it is referred to as an OEM (Original Equipment Manufacturer) audio/video device. In the case of OEM audio/video device, connections and command signals, etc. are predetermined and pre-installed by the manufacturer of the vehicle. Thus, as shown in FIG. 2, an OEM audio video/device (OEM A/V) 30 can be controlled by a user through the steering wheel control key assembly 22 as soon as the user purchases the vehicle. The OEM audio/video device 30 can also be controlled wirelessly with use of a remote controller 32.

A user sometimes wants to add a new device such as a portable audio/video player to his/her vehicle to use it in combination with the OEM audio/video device (head unit). Portable audio/video players such as iPod (by Apple Computer, Inc.) are popular devices to listen to music as well as to watch visual images. Typically, these device store music and video files which can be easily downloaded through wired or wireless network communication. Since the portable audio/video player typically includes a library of user's favorite music files, the user wants to reproduce such music files through the OEM audio/video device having a larger screen and a better sound quality speaker.

FIG. 3 shows an example of such a situation in which a portable audio/video player 25 is connected to an OEM audio/video device 30 of a vehicle through a link unit 27. The link unit 27 is specially designed to interface between the portable audio/video player 25 and the OEM audio/video device 30 by, for example, translating and converting command codes. In this situation, however, since the connections and protocols of command signals are pre-established between the control key assembly 22 on the steering wheel 20 and the OEM audio/video device 30, it is not possible to control the operations of the portable audio/video player 25 by the control key assembly 22. Thus, in the example of FIG. 3, the user has to operate the portable audio/video player 25 by directly touching a button (controller) or screen on the portable audio/video player 25 rather than by operating the control key assembly 22 on the steering wheel 20.

In another situation, a user may want to upgrade the audio/video system in the vehicle by installing a so called “aftermarket” audio/video device (head unit) to enjoy more new features in addition to the functions of the preexisting OEM audio/video device. Such a situation is shown in FIG. 4 in which an after market audio/video device (AFT A/V) 40 is installed in the vehicle. Unlike the OEM audio/video device 30 in FIG. 2, the aftermarket audio/video device 40 may not be controlled by the steering wheel control key assembly 22 if the aftermarket audio/video device 40 is directly connected with the steering wheel control key assembly 22 through wire or cables.

The user may have to lose the steering wheel control over the aftermarket audio/video device 40 unit unless an adaptor (link unit 37) is utilized to convert all OEM commands to be compatible and received by the aftermarket audio/video device 40. Although the inventors are not aware of such a link unit in actual applications, it may be available from a provider of the aftermarket audio/video device 40. However, in such a situation, the link unit 37 will function exclusively for the aftermarket audio/video device 40. The link unit 37 receives the command codes (data messages) from the steering wheel assembly 22 and converts the command codes to fit to the aftermarket audio/video device 40 and transmits the converted codes to the aftermarket audio/video device 40.

Thus, if the user wants to enjoy more features by the aftermarket audio/video device but does not want to completely replace the OEM audio/video device with it, a problem arises in which only one of the devices can be controlled by the steering control key assembly. Namely, the user can either keep using steering wheel control only for the OEM audio/video device (OEM A/V) 30 and manually control the aftermarket audio/video device (AFT A/V) 40, or use the steering wheel control only for the aftermarket audio/video device 40, and separately control the OEM audio/video device by the remote controller 32, etc.

Therefore, there is a need of an improved system and method for redefining the steering wheel commands to retain or redefine one or more OEM commands, while passing other commands to the OEM audio/video device so that the user can keep and enjoy the OEM audio/video device in addition to the new features of the after market audio/video device or other devices via steering wheel control assembly.

### SUMMARY OF THE INVENTION

It is, therefore, an object of the present invention to provide a method and apparatus which allows a user to control an original audio/video device as well as a non-original audio/video device installed in a vehicle by operating control keys on a steering wheel of the vehicle.

It is another object of the present invention to provide a method and apparatus incorporating an interface unit connected between a steering wheel control key assembly and one or more devices including original and non-original audio/video devices for controlling the operations of the devices via the control keys on the steering wheel.

It is a further object of the present invention to provide a method and apparatus incorporating an interface unit in which the interface unit allows the user to select one or more devices to substantiate a command code or feature defined by a user by operating the control key on the steering wheel.

It is a further object of the present invention to provide a method and apparatus incorporating an interface unit in which the interface unit interprets the command code from the control key on the steering wheel and converts the command code to that fits to the non-original device selected by the user and stores the converted command code in an initial setting procedure.

It is a further object of the present invention to provide a method and apparatus incorporating an interface unit in which the interface unit interprets the command code from the control key on the steering wheel and transmits the converted command code to the non-original device selected by the user in an application procedure.

One aspect of the present invention is a method of controlling operations of an original device and a non-original device in a vehicle through control keys mounted on a steering wheel. The method includes the steps of: interpreting a command code from the control key on the steering wheel when the control key is activated to determine which function assigned to the control key is selected; selecting one or more original or non-original devices in the vehicle to substantiate the selected function of the control key; retrieving data related to a command code of the selected function of the non-original device in the vehicle when the non-original device is included in the selected devices; converting the command code from the control key to a command code of the selected function of the non-original device and storing the converted command code; retrieving the converted command code and transmitting the converted command code to the non-original device when the control key is activated again; and transmitting the command code from the control key to the original device when the original device is included in the selected devices and when the control key is activated again.

In the present invention, the original device is a device originally installed in the vehicle when a user first obtained a new vehicle such that the relationship between the control key and the function of the original device is established, and the non-original device is a device installed after the user obtain the vehicle.

The method of the present invention further includes a step of connecting an interface unit between the control keys on the steering wheel and the one or more original or non-original devices in the vehicle. The interface unit includes a processor to control an overall operation of the interface unit, the original and non-original devices with respect to the control key on the steering wheel based on a computer program stored in a memory of the interface unit.

In the present invention, the step of interpreting the command code from the control key on the steering wheel is conducted by a code interpreter established in the interface unit. The step of selecting one or more devices in the vehicle is conducted through input keys and a display of the interface unit. The step of retrieving data related to the command code of the non-original device in the vehicle includes a step of detecting a type of the selected non-original device and retrieving information on the selected non-original device from a data table in the interface unit. The step of converting the command code and storing the converted command code is conducted by a code interpreter established in the interface unit based on the information from the data table.

In the method of present invention for controlling operations of an original device and a non-original device, the step of interpreting a command code from the control key on the steering wheel includes a step of creating a function new to the original device to control a particular function of the non-original device through the control key.

In the present invention, the original device is an OEM (Original Equipment Manufacturer) audio/video device, and the non-original device includes an after market audio/video device, a portable audio/video player, and a power amplifier system. The control key on the steering wheel is formed of a plurality keys each being assigned to a corresponding function including “volume up/down” for changing sound volume of the device, “source (power)” for turning-on a power of the device, and “mode” for selecting an operational mode of the device.

Another aspect of the present invention is an apparatus for controlling operations of the original device and non-original device in the vehicle through control keys mounted on a steering wheel. The apparatus interprets and converts the command codes from the control key on the steering wheel to control a desired function of either one or both of the original device and non-original device in the vehicle by implementing the various steps defined in the method invention noted above.

According to the present invention, the method and apparatus allows a user to control an original audio/video device as well as a non-original audio/video device installed in a vehicle by operating control keys on the steering wheel of the vehicle. To implement the present invention, the method and apparatus incorporates an interface unit connected between the control keys on the steering wheel and one or more devices including original and non-original audio/video devices for controlling the operations of the devices via the control keys. The interface unit allows the user to select one or more devices to substantiate a command code or feature defined by the user by operating the control key on the steering wheel. The interface unit interprets the command code from the control key and converts the command code to that fits to the non-original device selected by the user and stores the converted command code in the initial setting procedure. The interface unit interprets the command code from the control key on the steering wheel and transmits the converted command code to the non-original device selected by the user in the application procedure.

### BRIEF DESCRIPTION OF THE DRAWINGS

FIG. 1A shows an example of steering wheel of a vehicle having a plurality of control keys for typically controlling operations of an audio/video device in the vehicle, and FIG. 1B is a block diagram showing an example of basic structure of a control key assembly for generating command codes in response to the control keys on the steering wheel.

FIG. 2 is a schematic diagram showing an example of structural relationship between the steering wheel control key assembly and an OEM (Original Equipment Manufacturer) audio/video device in the vehicle.

FIG. 3 is a schematic diagram showing an example of application of a portable audio/video player in combination with the OEM audio/video device in the vehicle where the steering wheel control key assembly can be only used for controlling the OEM audio/video device.

FIG. 4 is a schematic diagram showing an example of structural relationship between the steering wheel control key assembly and an after market audio/video device added to the vehicle connected via a link unit.

FIG. 5 is a schematic diagram showing a basic concept of the present invention to selectively operate the OEM audio/video device and the after market audio/video device with use of the steering wheel control key assembly where an interface unit of the present invention is incorporated between the control keys and audio/video devices.

FIG. 6 is a block diagram showing an example of structure of the interface unit of the present invention for interpreting and converting command codes for controlling operations of various non-original devices added after purchasing the vehicle in addition to the original audio/video device.

FIGS. 7A and 7B are flow charts showing an example of application of the present invention with respect to the configuration of FIG. 5 where FIG. 7A shows an example of operational steps in an initial setting procedure of the present invention and FIG. 7B shows an example of operational steps in an application procedure of the present invention after the initial setting.

FIG. 8A is a schematic diagram showing an example of application of the present invention in which, in addition to the OEM audio/video device and the after market audio/video device, a portable audio/video player is controlled with use of the steering wheel control key assembly, and FIG. 8B is a flow chart showing an example of operational steps of the present invention for initial setting of the interface unit with respect to the portable audio/video player.

FIG. 9A is a schematic diagram showing an example of application of the present invention in which, in addition to the OEM audio/video device and the portable audio/video player, a power amplifier system is controlled with use of the steering wheel control key assembly, and FIG. 9B is a flow chart showing an example of operational steps of the present invention after the initial setting with respect to the volume control of the power amplifier system as well as the OEM audio/video device.

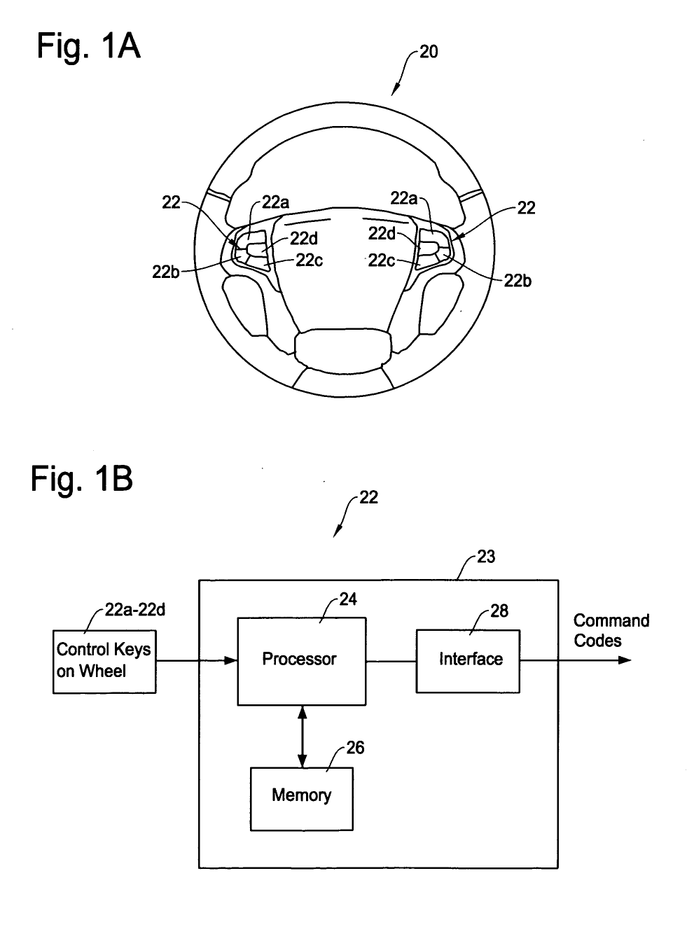

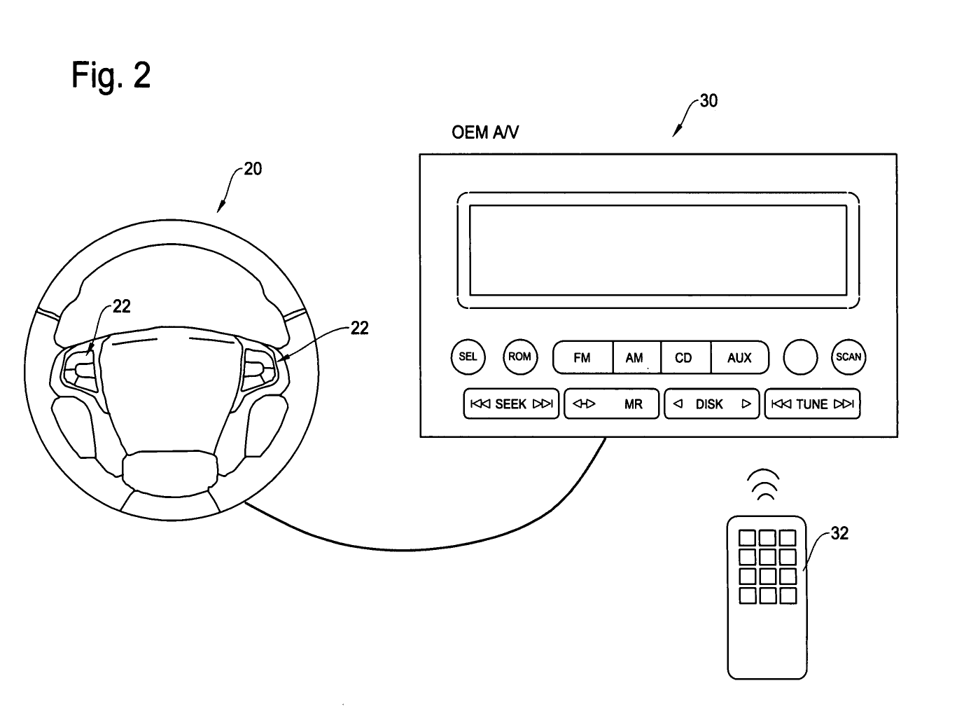

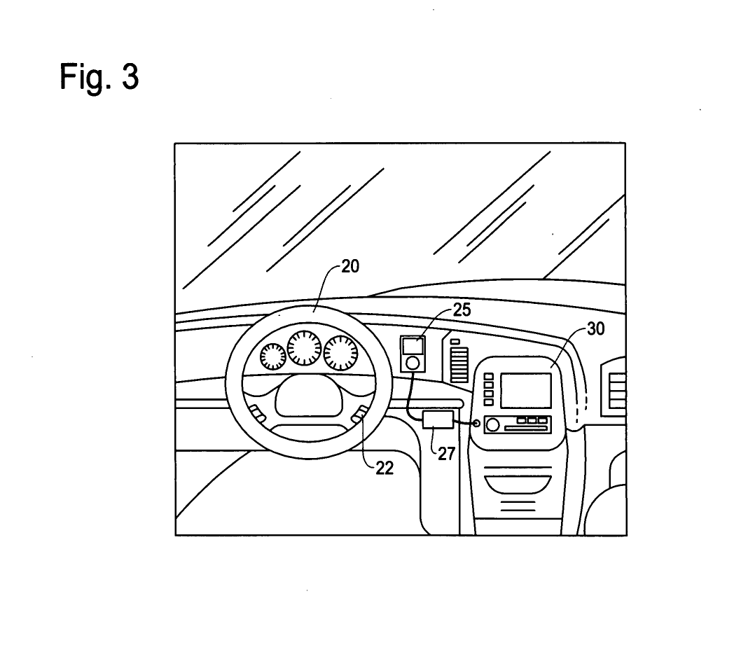

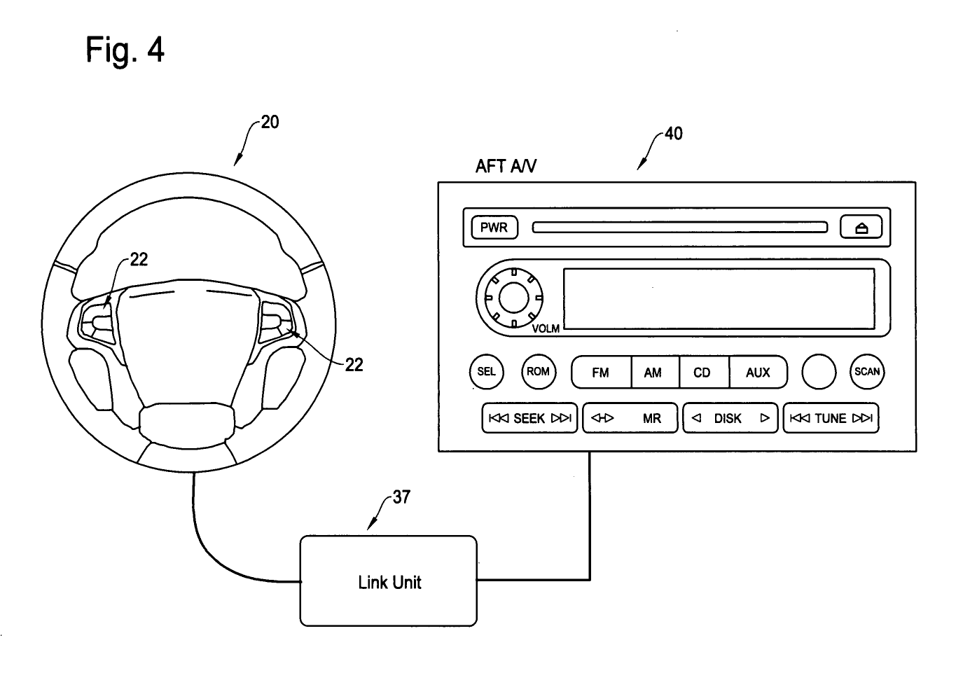

### DETAILED DESCRIPTION OF THE INVENTION

The method and apparatus of the present invention will be described in detail with reference to the accompanying drawings. The present invention is directed to the use of the steering wheel control key assembly for controlling operations of the various devices added to the vehicle in addition to the original audio/video device in the vehicle. The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

This invention relates to a method and apparatus for a steering wheel control key assembly connecting to an interface unit which is used to change some OEM (Original Equipment Manufacturer) commands to user-defined commands. As stated above, some users may want to keep their OEM audio/video device but add more features through various devices which were not installed when he/she purchased the vehicle. However, it may be inconvenient for the user if he/she has to keep using steering wheel control key assembly only for the OEM audio/video device and to separately control the added devices through a remote controller, or vise versa.

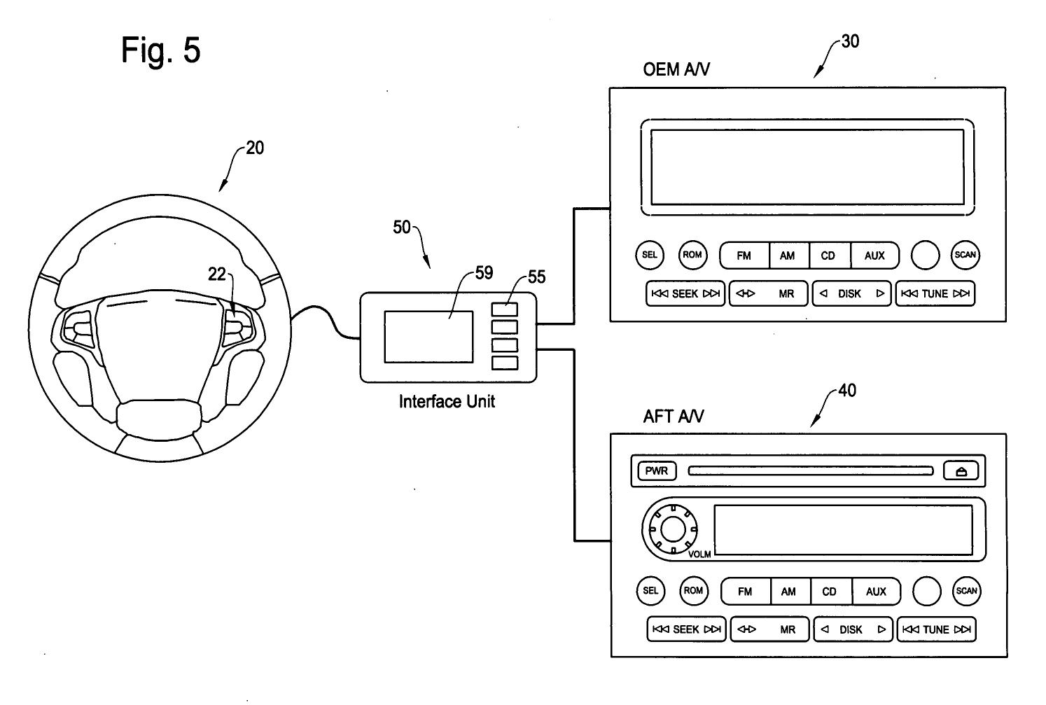

FIG. 5 is a schematic diagram showing a basic concept of the present invention to selectively operate the OEM audio/video device (original device) and the after market audio/video device (non-original device) with use of the steering wheel control key assembly where an interface unit of the present invention is incorporated. In this example, an interface device 50 is connected between the steering wheel control key assembly 22 on the steering wheel 20 and the OEM audio/video device 30 and the after market audio/video device 40. The interface unit 50 is designed to interpret and convert the command codes from the steering wheel control key assembly 22 to control a desired function of either one or both of the OEM audio/video device (OEM A/V) 30 and the after market audio/video device (AFT A/V) 40, or other device in the vehicle.

The interface unit 50 may have input keys 55 and a display 59 for allowing a user to initially select and preset a function and a device in the vehicle with respect to the operation of a certain control key of the steering wheel control key assembly 22 on the steering wheel 20. Such control keys on the steering wheel 20 include a “source (power)” key to select a device such as audio source, a “volume up/down” key for up/down control of the sound volume from the audio source, a “mode” key for selecting a mode such as a track, AM, FM, satellite, a file (ex. MP3), and a disc, etc, depending on the number of times the “mode” key is activated. Once a specific mode, such as “track” is selected, a user can specify a particular track by an additional operation of “up/down” key.

With use of the display 59 and the input keys 55 on the interface unit 50, the user can set the relationship between the control keys on the steering wheel with the functions or parameters (ex. volume, track, FM, etc.) of the device (ex., OEM audio/video device and the after market audio/video device). Within the concept of the present invention, such a process for the user to set the relationship between the control key and the function of the device is referred to as an initial setting procedure. Further, within the concept of the present invention, a process for the method and apparatus of the present invention to apply the established relationship between the control key and the function of the device is referred to as an application procedure.

For example, with respect to the “volume” key on the steering wheel 20, the user may set the interface unit 50 so that the volume of both the OEM audio/video device 30 and the after market audio/video device 40 will be controlled by this key. With respect to the “source (power)” key on the steering wheel 20, the user may set the interface unit 50 so that the power of the after market audio/video device 40 is turned-on by the first click of the “source” key. Further, the user may so set that the powers of both the after market audio/video device 40 and the OEM audio/video device 30 are turned-on by second click of the “source” key, and only the OEM audio/video device 30 is turned-on by the third click of the source key, and so on.

Further, with respect to the “mode” key on the steering wheel 20, the user may set the interface unit 50 so that the disc in the after market audio/video device 40 is changed by the “mode” key and the “up/down” key. Thus, in this example, the OEM audio/video device 30 is disabled in terms of changing the disc by the “mode” key. The user may set the interface unit 50 such that the FM radio and AM radio of both of the after market audio/video device 40 and the OEM audio/video device 30 will be changed at the same time by the “mode” key, and so on. The type of mode will be detected by counting the number of times the user presses the “mode” key, and when the mode intended by the user, such as “disc” is detected, the disc will be changed in response to the operation of the “up/down” key that follows.

In such an initial setting procedure, the interface unit 50 interprets the original command code from the control key, converts the command code to that fits to the non-original device, and stores the converted command code to be retrieved in an application procedure. Once the initial setting procedure is completed, the interface unit 50 automatically interprets the command code from the control key on the steering wheel in response to the operation of the control key on the steering wheel and selects the function of the selected device.

In the above case, for example, when the user presses the “volume” key of the steering wheel control key assembly on the steering wheel 20, the interface unit 50 interprets the command code such that the user wants to control the volumes of both the after market audio/video device 40 and the OEM audio/video device 30. Thus, the interface unit 50 retrieves the converted command code and sends the converted command code to the audio/video device to change its sound volume. At the same time, the interface unit 50 sends the original command code to the OEM audio/video device 30 to change its sound volume.

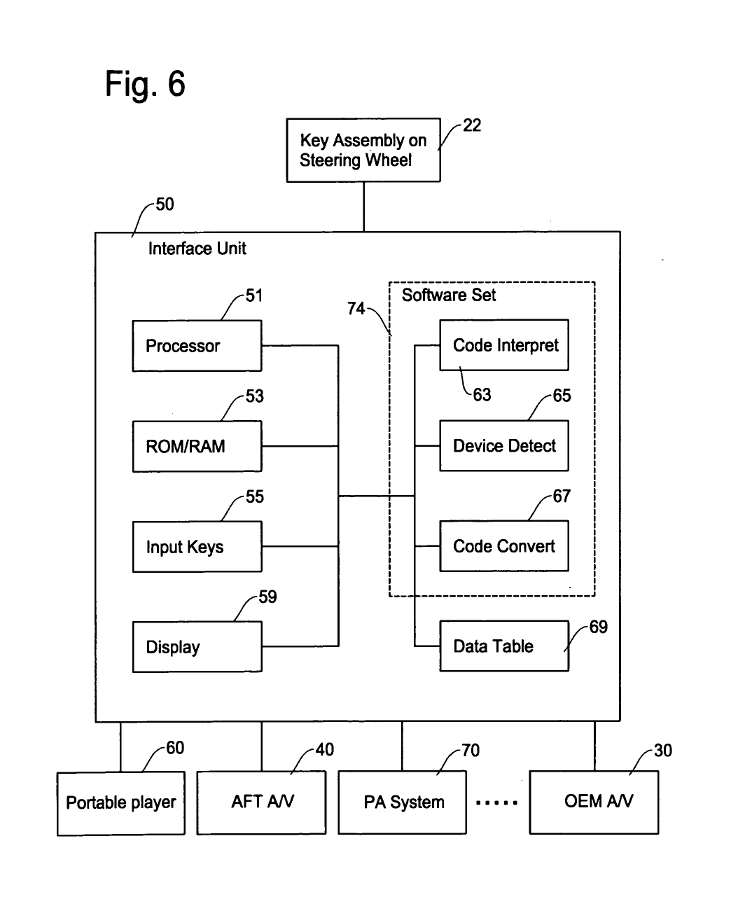

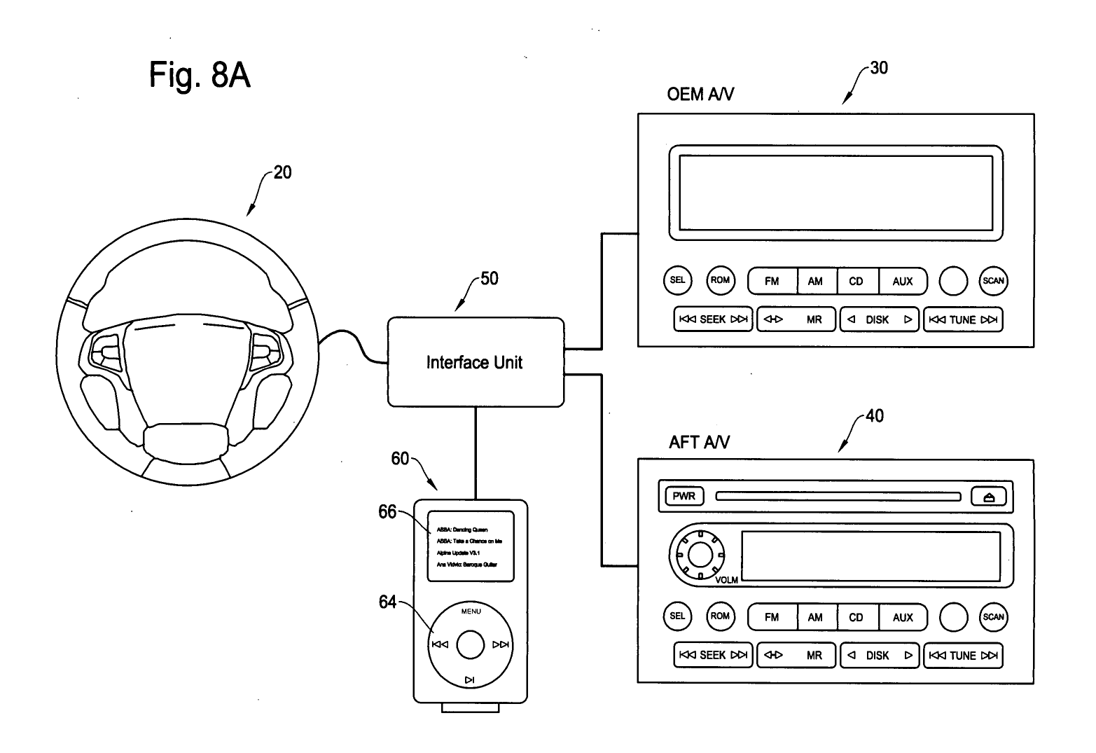

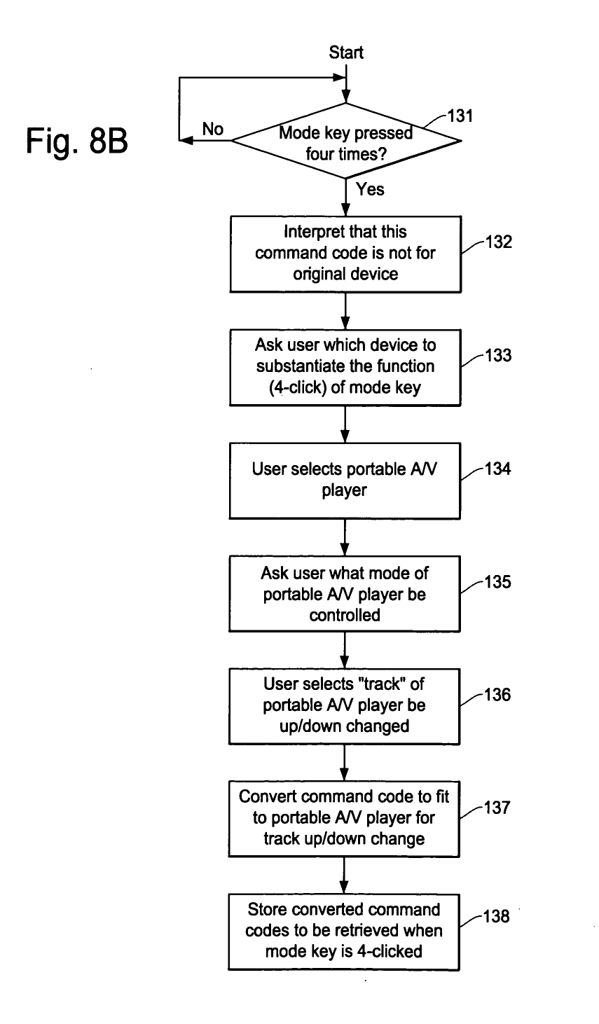

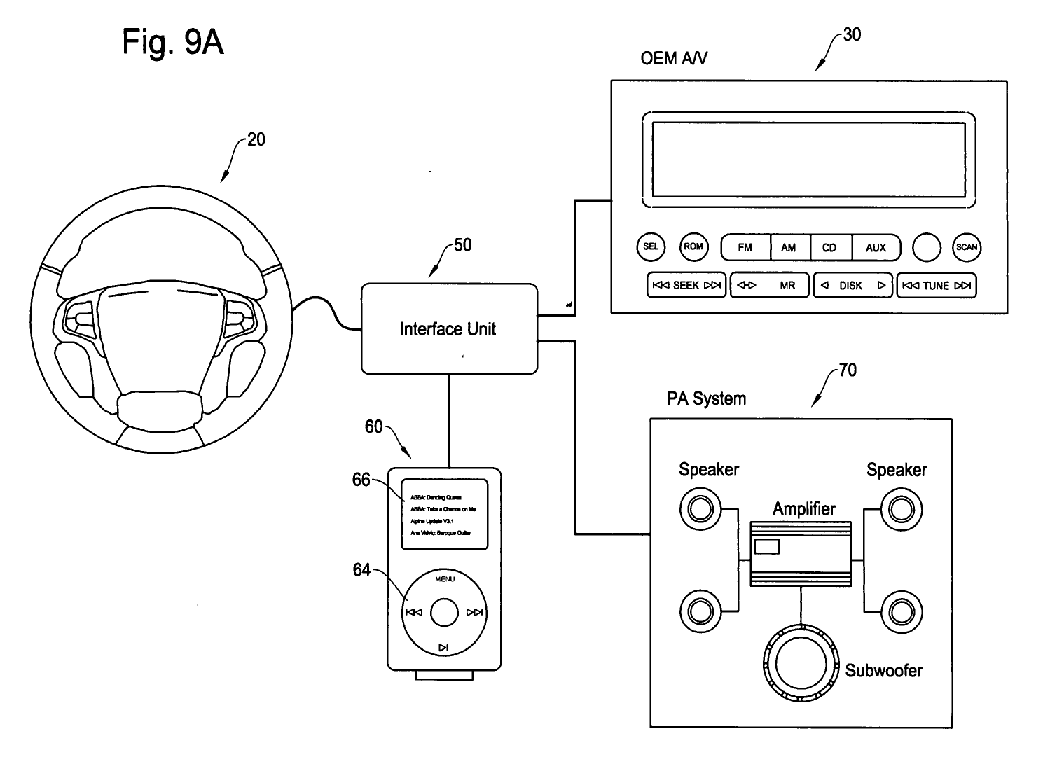

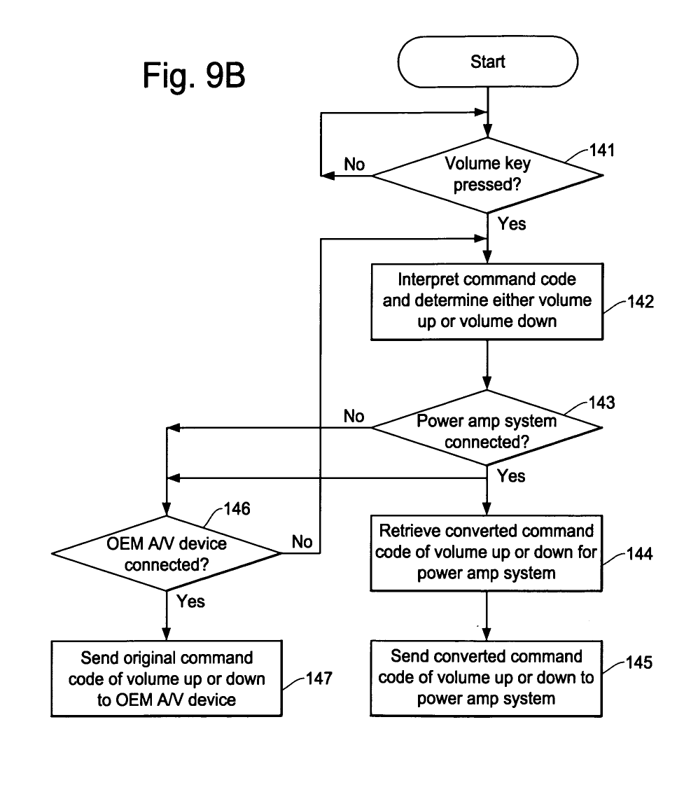

FIG. 6 is a functional block diagram showing an example of structure and components of the interface unit 50 of the present invention. The interface unit 50 is designed to interpret and convert the command codes for controlling operations of various non-original devices (ex. audio/video device 40) added to the vehicle in addition to the original device (ex. OEM audio/video device 30). As shown in FIG. 5, the interface device 50 may be connected between the steering wheel control key assembly 22 of a vehicle and the various devices in the vehicle. As noted above such various devices include an original device such as an OEM audio/video device 30 as well as a non-original device such as an after market audio/video device 40, a portable audio/video player 60 (FIG. 8A), a power amplifier system (FIG. 9A), etc.

The interface unit 50 includes a ROM/RAM 53 which stores a program (in ROM) and temporarily store associated data (in RAM) to carry out the operation of the interface unit 50, a processor 51 to control an overall operation of the interface unit 50 by executing the program stored in the ROM/RAM 53, input keys 55 and a display 59 which allow the user to specify and select as to which command codes from the steering wheel control key assembly 22 should be used to control which functions and devices in the vehicle, a data table 69 which stores various data concerning types of devices and their functions, types of command codes, etc., and a software set 71 that has one of more software tools for implementing the specific operations of the interface unit 50, in this example, a code interpreter 63, a device detector 65 and a code converter 67.

The interface unit 50 performs the procedures described with respect to the block diagram shown in FIG. 5 under the control of the processor 51. In the software set 71, the code interpreter 63 interprets the command codes from the steering wheel control key assembly 22 on the steering wheel 20 of the vehicle. The device detector 65 checks which devices are connected to the interface unit 50 for the purpose of control through the control keys on the steering wheel 20. In the example of FIG. 6, such devices include an OEM audio/video device 30, an after market audio/video device 40, a portable audio/video player 60, and a power amplifier system 70, etc. The code converter 67 converts, if necessary, the command code from the steering wheel control key assembly 22 to a type of command code that can control the function and device selected by the user through the initial setting procedure by the user.

In the initial setting procedure, the present invention incorporating the interface unit 50 operates as follows. For example, in the situation where the user wants to use the “volume” key on the steering wheel 20 to control the sound volume of both the OEM audio/video device 30 and the after market audio/video device 40 as noted above, the user may first activate the “volume” key. The code interpreter 63 interprets the command code from the “volume” key and, as a result, the interface unit 50 may show a message on the display 59 such as “Control Volume?” to prompt the user to answer “Yes” or “No”. This process may be necessary if the user wants to change the original function “volume” of the key on the steering wheel to other function such as “Bass” or “Echo”, if not, this process may not be necessary. When the user indicates “Yes”, the interface unit 50 shows the next message on the display 59 such as “Select Device” to prompt the user to specify either the OEM audio/video device 30 or the after market audio/video device 40 or both to up/down control the sound volume. In the situation noted above, the user selects both the OEM audio/video device 30 and the after market audio/video device 40 by operating the input keys 55. In the case where the display 59 is a touch screen, the input keys 55 can be implemented on the display 59.

The device detector 65 is able to check which devices are connected to the interface unit 50 so that the interface unit 50 can retrieve the data such as command codes from the data table 69 for controlling the volume up/down of the after market audio/video device 40. Based on the data from the data table 69, the code converter 67 converts the command code from the steering wheel control key assembly 22 to a type of command code that can up/down control the volume of the after market audio/video device 40. The converted command code is stored in the interface unit 50 such as in the data table 69 so that the converted command code will be directly used when the “volume” key is activated in the application procedure.

In the application procedure, i.e., after completing the initial setting procedure noted above, every time when the user activates the “volume up/down” key on the steering wheel 20, the interface unit 50 retrieves, in response to the signal from the code interpreter 63, the converted command code from the data table 69. The interface unit 50 transmits the converted command code to the after market audio/video device 40 to control its sound volume. Since it is unnecessary to change the command code for the OEM audio/video device 30, the interface unit 50 transmits the original command code to the OEM audio/video device 30 when the “volume up/down” key is operated. As noted above, the foregoing operations of the interface unit 50 are controlled by the processor 51 based on the program stored in the ROM/RAM 53.

Reference is made with respect to the operation of the interface unit 50 for the “source (power)” key on the steering wheel 20, in the specific order as noted above with reference to FIG. 5. In the initial setting procedure, the user wants to preset the interface unit 5 the specific order of devices to be turned-on based on the number of times this key is pressed. When the user activates the “source” key, the code interpreter 63 in the interface unit 50 detects that the “source” key is activated. Then, the interface unit 50 may show the message “Select Device (1st click)” to prompt the user to select the device for the first click of the “source” key.

In the above example, the user wants the power of the after market audio/video device 40 is turned-on by the first click of the “source” key, thus, in response, the user selects the after market audio/video device 40. The device detector 65 detects a type or model of the after market audio/video device 40 so that a command code to turn-on the after market audio/video device 40 is created or converted by the code converter 67 based on the information from the data table 69. The command code created in this manner is stored in the interface unit 50 such as in the data table 69 to be retrieved in the application procedure.

Then, the interface unit 50 may show the message “Select Device (2nd click)” to prompt the user to select the device for the second click of the “source” key. In the above example, since the user wants to turn-on both the after market audio/video device 40 and the OEM audio/video device 30, he/she selects the both devices. The interface unit 50 stores the information that both the after market audio/video device 40 and the OEM audio/video device 30 should be turned-on by the second click of the “source” key. Similarly, the user presets the interface unit 50 so that only the OEM audio/video device 30 is turned-on by the third click of the “source” key, the information of which is stored in the interface unit 50.

After the initial setting procedure of the “source” key noted above, when the user activates the “source” key on the steering wheel 20 once, the interface unit 50 retrieves, in response to the detection signal from the code interpreter 63, the converted command code from the data table 69. The interface unit 50 transmits the converted command code to the after market audio/video device 40 to turn-on its power. When the user presses the “source” key twice, the interface unit 50 transmits, based on the information stored therein, the original command code to the OEM audio/video device 30 to turn-on its power as well as the converted command code to the after market audio/video device 40 to turn-on its power. When the “source” key is pressed three times, the interface unit 50 turns-off the power of the after market audio/video device 40 so that only the OEM audio/video device 30 operates.

With respect to the operation of the interface unit 50 for the “mode” key on the steering wheel 20, in the above example noted with reference to FIG. 5, the user wants to preset the interface unit 5 to change the disc in the after market audio/video device 40. Namely, the user does not want the OEM audio/video device 30 to respond to this key operation to change the disc therein. Typically, the “mode” key is used to select a mode of operation based on the number of times the “mode” key is pressed. When the mode intended by the user, such as “disc” is detected, the disc in the intended device will be changed in response to the operation of an “up/down” key that follows.

It is assumed that the order of selection by the “mode” key of the original system (OEM A/V device 30) is “FM” for first click, “AM” for second click, and “disc” for third click, respectively. In this situation, when the user activates the “mode” key three times, the code interpreter 63 in the interface unit 50 detects that the “mode” key is activated and its intended mode is “disc” change. Then, the interface unit 50 will display the message “Select Device” to prompt the user to select the device for the “mode” key (disc change). In the above example, the user wants the disc only in the after market audio/video device 40 is changed by this mode, thus, in response, the user selects only the after market audio/video device 40.

As noted above, since the device detector 65 knows the specific type of the after market audio/video device 40 so that a command code to change the disc in the after market audio/video device 40 is created or converted by the code converter 67 based on the information from the data table 69. The command codes converted in this manner are stored in the interface unit 50 such as in the data table 69 so that when the mode “disc change” is specified and the “up/down” key is operated, the stored command codes will be sent to the after market audio/video device 40. Since the user did not select the OEM audio/video device 30 to respond to this mode (disc change), the interface unit 50 remembers this setting so that the command code to change the disc will not be transmitted to the OEM audio/video device 30 when this key is activated in the application procedure.

After the initial setting procedure of the “mode” key noted above, when the user activates the “mode” key on the steering wheel 20 three times, the interface unit 50 retrieves, in response to the detection signal from the code interpreter 63, the converted command code from the data table 69. The interface unit 50 transmits the converted command code to the after market audio/video device 40 to change the disc in response to the up/down operation of the control key on the steering wheel. Since the user did not select the OEM audio/video device 30 to respond to this mode (disc change), the interface unit 50 will not transmit the original command code to the OEM audio/video device 30.

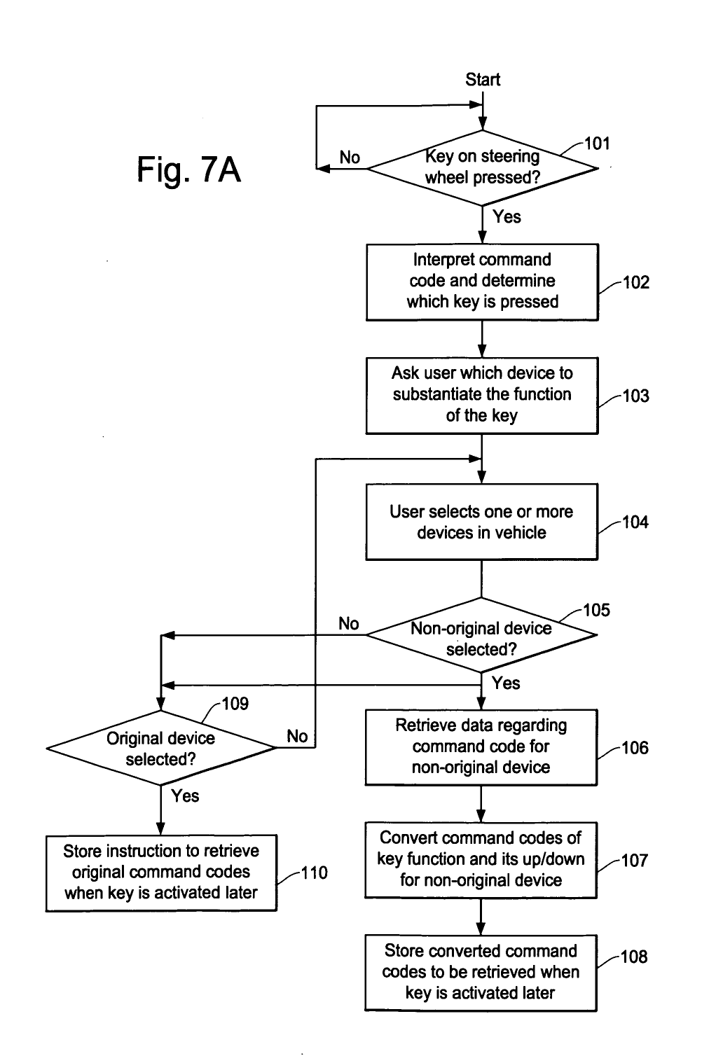

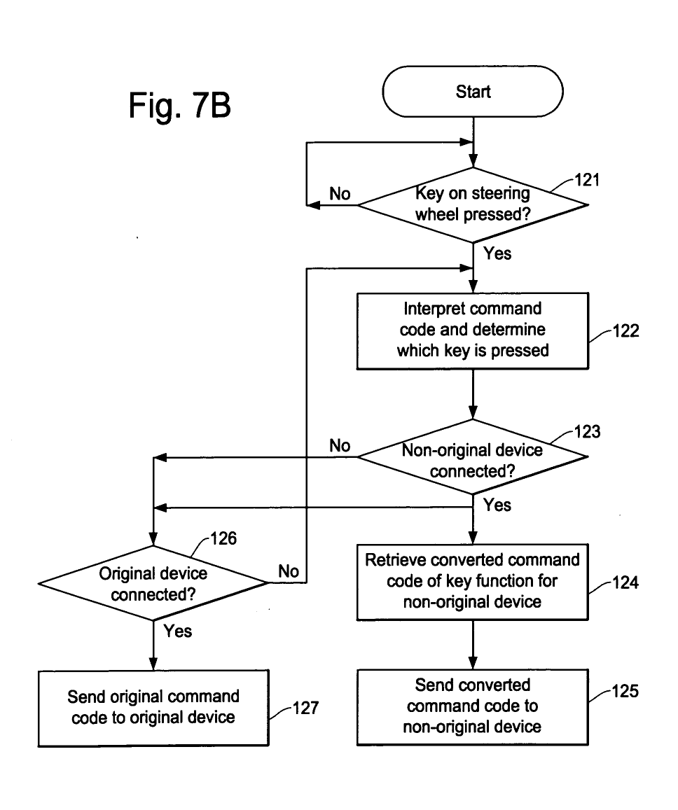

FIGS. 7A and 7B are flow charts showing an example of operation of the present invention in the case where the vehicle includes the OEM audio/video device 30 and the after market audio/video device 40 as in the configuration of FIG. 5. FIG. 7A shows an example of operational steps in an initial setting procedure involving the interface unit 50 for defining the relationship between the control key on the steering wheel 20 and the after market audio/video device 40. FIG. 7B shows an example of operational steps in an actual application procedure with respect to the OEM audio/video device 30 and the after market audio/video device 40 after the initial setting procedure of FIG. 7A.

The initial setting procedure of FIG. 7A shows the case where the user wants to apply a function of a certain control key on the steering wheel equally to two devices. As shown in FIG. 5, the two devices are an original device (OEM audio/video device 30) and a non-original device (after market audio/video device 40). The initial setting procedure is to establish, in the interface unit 50 of the present invention, a relationship between a control key on the steering wheel 20 and a function or parameter of the devices 30 and 40 in the vehicle.

In FIG. 7A, when the initial setting procedure starts, the interface unit 50 keeps checking whether a control key on the steering wheel 20 (steering wheel control key assembly 22) is activated by the user at step 101. It is assumed that the user wants to use the “volume up/down” key on the steering wheel 20 to control the sound volume of both the OEM audio/video device 30 and the after market audio/video device 40. Thus, when the user presses the “volume up/down” control key (“Yes” in step 101), the initial setting procedure detects which control key was activated in step 102. This step is done by the interface unit 50 (code interpreter 63) which interprets the command code from the control key and determines that the “volume up/down” control key was activated.

Then, in step 103, the interface unit 50 displays a message on the display 59 such as “Select Device” to prompt the user to specify either one of the OEM audio/video device 30 and the after market audio/video device 40 or both to up/down control the sound volume. In other words, this step is to determine to which device the volume control function should be substantiated. In step 104, since the user wants to control the volume of both devices, he/she selects both the OEM audio/video device 30 and the after market audio/video device 40 by operating the input keys 55.

In step 105, the initial setting procedure checks whether the user has selected a non-original device in the previous step (step 104). In the configuration of FIG. 6, the device detector 65 in the interface unit 50 is able to detect which devices are connected to the interface unit 50 so that it is able to identify that the selected device is an original or non-original device. Since the after market audio/video device 40 is a non-original device, in step 106, the initial setting procedure retrieves the data such as command codes from the data table 69 for controlling the volume up/down of the after market audio/video device 40.

In step 107, based on the data from the data table 69, the initial setting process converts the command code from the “volume up/down” key to that appropriate to the non-original device, i.e., after market audio/video device 40. This step is done by the code converter 67 which converts the command code from the steering wheel control key assembly 22 to a type of command code that can up/down control the volume of the after market audio/video device 40. In step 108, the converted command code is stored in the interface unit 50 such as in the data table 69 so that the converted command code will be directly used when the “volume up/down” key is activated later after the initial setting procedure.

In step 109, initial setting procedure also checks whether the original device was also selected by the user to substantiate the “volume up/down” control key. Since the user selected both the OEM audio/video device 30 and the after market audio/video device 40 in the step 104 as noted above, the procedure determines that the original device was also selected. Thus, in step 110, the initial setting procedure stores the instruction so that the interface unit 50 retrieves and sends the original command code of the OEM audio/video device 30 when the “volume up/down” key is activated later in the application procedure.

The application procedure of FIG. 7B shows the case where the user actually applies the relationship between the control key on the steering wheel 20 and the function or parameter of the devices 30 and 40 established in the initial setting procedure of FIG. 7A. When the application procedure starts, the interface unit 50 keeps checking whether a control key on the steering wheel 20 (steering wheel control key assembly 22) is activated by the user at step 121. When the user presses the “volume up/down” control key, the application procedure detects which control key was activated in step 122. This step is done by the code interpreter 63 in the interface unit 50 which interprets the command code from the control key and determines that the “volume up/down” control key was activated.

Then, in step 123, the application procedure checks whether the non-original device selected in the initial setting procedure is connected to the interface unit 50. Since the device detector 65 is able to detect which devices are connected to the interface unit 50, the application procedure determines that the after market audio/video device 40 is connected to the interface unit 50. In the initial setting procedure noted above, the converted command code for the “volume up/down” control of the after market audio/video device 40 has been created and stored in the interface unit 50.

Thus, in step 124, the application procedure retrieves the converted command code for the after market audio/video device 40 from the data table 69 in the interface unit 50. In step 125, the interface unit 50 transmits the converted command code to the after market audio/video device 40 to control its sound volume. Consequently, the control key on the steering wheel is able to control the operation of the after market audio/video device 40 which was not originally included in the vehicle.

At step 126, the application procedure determines that the original device, i.e., the OEM audio/video device 30, is also connected to the interface unit 50 in the manner shown in FIG. 5. Since it is unnecessary to change the command code for the OEM audio/video device 30, the application procedure transmits the original command code to the OEM audio/video device 30 in step 127. Consequently, the “volume up/down” control key on the steering wheel is able to control the sound volume of both the after market audio/video device 40 and the OEM audio/video device 30.

FIG. 8A is a schematic diagram showing an example of application of the present invention where, in addition to the OEM audio/video device 30 and the after market audio/video device 40, a portable audio/video player 60 is installed in the vehicle. In the method and apparatus of the present invention involving the interface unit 50, the portable audio/video player 60 can be controlled with use of the steering wheel control key assembly 22. FIG. 8B is a flow chart showing an example of operation of the present invention for initial setting of the interface unit with respect to the situation shown in FIG. 8A.

In the example of FIG. 8A, the interface unit 50 is connected between the steering wheel control key assembly 22 on the steering wheel 20 and the portable audio/video player 60. Similar to the example of FIG. 5, the OEM audio/video device (OEM A/V) 30 and the after market audio/video device (AFT A/V) 40 are also connected to the interface unit 50. The portable audio/video player 60, an example of which is iPod (by Apple Computer, Inc., California, USA), includes a screen 66 and a controller 64 as is known in the art.

The initial setting procedure of FIG. 8B is directed to the situation where the user wants to establish the relationship between the “mode” key on the steering wheel control key assembly 22 and the portable audio/video player 60 shown in FIG. 8A. Typically, depending on the number of times the user presses the “mode” key, the mode such as AM, FM, disc, etc, will change. Once a specific mode, such as “track” is selected, a user can specify a particular track by an additional operation of an “up/down” key.

In the example of FIG. 8B, it is assumed that the user wants to set the interface unit 50 so that when the “mode” key is pressed four times (4-click), a mode “track” of the portable audio/video player 60 is selected. It is also assumed that no specific mode has been assigned with respect to the four times activation (4-click) of the “mode” key for the original device (ex. OEM audio/video device 30). In other words, the initial setting procedure of FIG. 8B includes an operation for creating a new function not included in the original device.

In step 131, the initial setting procedure keeps checking the number times of the “mode” key's access to detect whether the user has pressed the “mode” key four times. When the user presses the “mode” key four times (“Yes” in step 131), the initial setting procedure detects that a command code resulted from the “mode” key is not defined for the original device in step 132. This step is done by the interface unit 50 (code interpreter 63) which interprets the command codes from the control keys on the steering wheel and determines that 4-click of the “mode” key is not assigned to any device. Thus, in step 133, the interface unit 50 asks the user via the display 59 which device to substantiate the 4-click “mode” key operation by showing, for example, “Select Device”.

In step 134, since the user wants to change the track of the portable audio/video player 60, he/she selects the portable audio/video player by operating the input keys 55. In step 135, the initial setting procedure further asks the user what mode of the portable audio/video player should be controlled by an “up/down key” after the 4-click of the “mode” key. In response, in step 136, the user selects “track” since he/she wants to change the track of the portable audio/video player 60.

Since the portable audio/video player 60 is a non-original device, the interface unit 59 retrieves the data such as command codes from the data table 69 for changing the track of the portable audio/video player 60. Thus, in step 137, based on the data from the data table 69, the initial setting process converts the command code from the “mode” key and the up/down key to that appropriate to the portable audio/video player 60. This step is done by the code converter 67 which converts the command codes from the steering wheel control key assembly 22 to command codes that is appropriate to up/down control the track of the portable audio/video player 60. In step 138, the converted command codes are stored in the interface unit 50 such as in the data table 69 so that the converted command codes will be directly used when the “mode” key is activated four times after the initial setting procedure.

FIG. 9A is a schematic diagram showing an example of application of the present invention where, in addition to the OEM audio/video device 30 and the portable audio/video player 60, a power amplifier system 70 is installed in the vehicle. In the method and apparatus of the present invention involving the interface unit 50, the power amplifier system 70 can be controlled with use of the steering wheel control key assembly 22. FIG. 9B is a flow chart showing an example of application procedure of the present invention after the initial setting with respect to the volume control of the power amplifier system.

In the example of FIG. 9A, the interface device 50 is connected between the steering wheel control key assembly 22 on the steering wheel 20 and the power amplifier system 70. Similar to FIG. 8A, the OEM audio/video device (OEM A/V) 30 and the portable audio/video player 60 are also connected to the interface unit 50. The power amplifier system 70 typically includes a high power audio amplifier, a plurality of loudspeakers typically installed at front and back of the vehicle, and a subwoofer specially designed for producing low frequency audio sounds with high power.

The application procedure of FIG. 9B shows the case where the user actually applies the relationship between the control key on the steering wheel 20 and the function or parameter of the devices in the vehicle established in the initial setting procedure. In the example of FIG. 9B, it is assumed that the user has already set, in the initial setting procedure similar to that shown in FIG. 7A, so that when the “volume up/down” key on the steering wheel 20 is pressed, the sounds of both the OEM audio/video device 30 and the power amplifier system 70 are up/down controlled. In step 141, the application procedure (interface unit 50) keeps checking whether a “volume up/down” key on the steering wheel 20 (steering wheel control key assembly 22) is activated by the user.

When the user presses the “volume up/down” control key, on the steering wheel 20, in step 142, the application procedure interprets the command code derived from the operation of the “volume up/down” control key to determine whether it is volume up of volume down. This step is done by the code interpreter 63 in the interface unit 50 which interprets the command codes from the control key on the steering wheel. Then, in step 143, the application procedure checks whether the power amplifier system 70 (selected in the initial setting procedure) is connected to the interface unit 50. Since the device detector 65 is able to detect which devices are connected to the interface unit 50, the application procedure determines that the power amplifier system 70 is connected to the interface unit 50. Similar to the example of FIG. 7A, in the initial setting procedure noted above, the converted command code for the “volume up/down” control of the power amplifier system 70 has been created and stored in the interface unit 50.

Thus, in step 144, the application procedure retrieves the converted command code for the power amplifier system 70 from the data table 69 in the interface unit 50. In step 145, the interface unit 50 transmits the converted command code to the power amplifier system 70 to control its sound volume. Consequently, the control key on the steering wheel 20 is able to control the operation of the power amplifier system 70 which was not originally included in the vehicle.

At step 146, the application procedure determines that the original device, i.e., the OEM audio/video device 30, is also connected to the interface unit 50 in the manner shown in FIG. 9A. Since it is unnecessary to change the command code for the OEM audio/video device 30, the application procedure transmits the original command code to the OEM audio/video device 30 in step 147. Consequently, the “volume up/down” control key on the steering wheel 20 is able to control the sound volume of both the power amplifier system 70 and the OEM audio/video device 30.

As has been described above, according to the present invention, the method and apparatus allows a user to control an original audio/video device as well as a non-original audio/video device installed in a vehicle by operating control keys on the steering wheel of the vehicle. To implement the present invention, the method and apparatus incorporates an interface unit connected between the control keys on the steering wheel and one or more devices including original and non-original audio/video devices for controlling the operations of the devices via the control keys. The interface unit allows the user to select one or more devices to substantiate a command code or feature defined by the user by operating the control key on the steering wheel. The interface unit interprets the command code from the control key and converts the command code to that fits to the non-original device selected by the user and stores the converted command code in the initial setting procedure. The interface unit interprets the command code from the control key on the steering wheel and transmits the converted command code to the non-original device selected by the user in the application procedure.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method of controlling operations of an original device and a non-original device in a vehicle through control keys mounted on a steering wheel, comprising the following steps of:
interpreting a command code from the control key on the steering wheel when the control key is activated to determine which function assigned to the control key is selected;
selecting one or more original or non-original devices in the vehicle to substantiate the selected function of the control key;
retrieving data related to a command code of the selected function of the non-original device in the vehicle when the non-original device is included in the selected devices;
converting the command code from the control key to a command code of the selected function of the non-original device and storing the converted command code;
retrieving the converted command code and transmitting the converted command code to the non-original device when the control key is activated again; and
transmitting the command code from the control key to the original device when the original device is included in the selected devices and when the control key is activated again;
wherein the original device is a device originally installed in the vehicle when a user first obtained a new vehicle such that the relationship between the control key and the function of the original device is established, and the non-original device is a device installed after the user obtain the vehicle.

2. A method of controlling operations of an original device and a non-original device as defined in claim 1, further comprising a step of connecting an interface unit between the control keys on the steering wheel and the one or more original or non-original devices in the vehicle.

3. A method of controlling operations of an original device and a non-original device as defined in claim 2, wherein said interface unit includes a processor to control an overall operation of the interface unit, the original and non-original devices with respect to the control key on the steering wheel based on a computer program stored in a memory of the interface unit.

4. A method of controlling operations of an original device and a non-original device as defined in claim 3, wherein said step of interpreting the command code from the control key on the steering wheel is conducted by a code interpreter established in the interface unit.

5. A method of controlling operations of an original device and a non-original device as defined in claim 3, wherein said step of selecting one or more devices in the vehicle is conducted through input keys and a display of the interface unit.

6. A method of controlling operations of an original device and a non-original device as defined in claim 3, wherein said step of retrieving data related to the command code of the non-original device in the vehicle includes a step of detecting a type of the selected non-original device and retrieving information on the selected non-original device from a data table in the interface unit.

7. A method of controlling operations of an original device and a non-original device as defined in claim 3, wherein said step of converting the command code and storing the converted command code is conducted by a code interpreter established in the interface unit based on the information from the data table.

8. A method of controlling operations of an original device and a non-original device as defined in claim 1, wherein said step of interpreting a command code from the control key on the steering wheel includes a step of creating a function new to the original device to control a particular function of the non-original device through the control key.

9. A method of controlling operations of an original device and a non-original device as defined in claim 1, wherein said original device is an OEM (Original Equipment Manufacturer) audio/video device, and said non-original device includes an after market audio/video device, a portable audio/video player, and a power amplifier system.

10. A method of controlling operations of an original device and a non-original device as defined in claim 9, wherein said control key on the steering wheel is formed of a plurality keys each being assigned to a corresponding function including “volume up/down” for changing sound volume of the device, “source (power)” for turning-on a power of the device, and “mode” for selecting an operational mode of the device.

11. An apparatus for controlling operations of an original device and a non-original device in a vehicle through control keys mounted on a steering wheel, comprising:
means for interpreting a command code from the control key on the steering wheel when the control key is activated to determine which function assigned to the control key is selected;
means for selecting one or more original or non-original devices in the vehicle to substantiate the selected function of the control key;
means for retrieving data related to a command code of the selected function of the non-original device in the vehicle when the non-original device is included in the selected devices;
means for converting the command code from the control key to a command code of the selected function of the non-original device and storing the converted command code;
means for retrieving the converted command code and transmitting the converted command code to the non-original device when the control key is activated again; and
means for transmitting the command code from the control key to the original device when the original device is included in the selected devices and when the control key is activated again;
wherein the original device is a device originally installed in the vehicle when a user first obtained a new vehicle such that the relationship between the control key and the function of the original device is established, and the non-original device is a device installed after the user obtain the vehicle.

12. An apparatus for controlling operations of an original device and a non-original device as defined in claim 1, further comprising an interface unit provided between the control keys on the steering wheel and the one or more original or non-original devices in the vehicle.

13. An apparatus for controlling operations of an original device and a non-original device as defined in claim 12, wherein said interface unit includes a processor to control an overall operation of the interface unit, the original and non-original devices with respect to the control key on the steering wheel based on a computer program stored in a memory of the interface unit.

14. An apparatus for controlling operations of an original device and a non-original device as defined in claim 13, wherein said means for interpreting the command code from the control key on the steering wheel is conducted by a code interpreter established in the interface unit.

15. An apparatus for controlling operations of an original device and a non-original device as defined in claim 13, wherein said means for selecting one or more devices in the vehicle is conducted through input keys and a display of the interface unit.

16. An apparatus for controlling operations of an original device and a non-original device as defined in claim 13, wherein said means for retrieving data related to the command code of the non-original device in the vehicle includes means for detecting a type of the selected non-original device and retrieving information on the selected non-original device from a data table in the interface unit.

17. An apparatus for controlling operations of an original device and a non-original device as defined in claim 13, wherein said means for converting the command code and storing the converted command code is conducted by a code interpreter established in the interface unit based on the information from the data table.

18. An apparatus for controlling operations of an original device and a non-original device as defined in claim 11, wherein said means for interpreting a command code from the control key on the steering wheel includes means for creating a function new to the original device to control a particular function of the non-original device through the control key.

19. An apparatus for controlling operations of an original device and a non-original device as defined in claim 11, wherein said original device is an OEM (Original Equipment Manufacturer) audio/video device, and said non-original device includes an after market audio/video device, a portable audio/video player, and a power amplifier system.

20. An apparatus for controlling operations of an original device and a non-original device as defined in claim 19, wherein said control key on the steering wheel is formed of a plurality keys each being assigned to a corresponding function including “volume up/down” for changing sound volume of the device, “source (power)” for turning-on a power of the device, and “mode” for selecting an operational mode of the device.
